(19) United States
(12) Patent Application Publication
(10) Pub. No.: US 2004/0117230 A1
(43) Pub. Date: Jun. 17, 2004

(54) Recalculating planned requests

(76) Inventors: Kevin Thomas Jones, Austin, TX (US); Melissa Doris Beebe, Cedar Park, TX (US); Jeffrey Alan Marrs, Lago Vista, TX (US); Michael Shane Castle, Round Rock, TX (US)

Correspondence Address: HAMILTON & TERRILE, LLP, P.O. BOX 203518, AUSTIN, TX, 78720, US

(21) Appl. No.: 10/320,889

(22) Filed: Dec. 16, 2002

(51) Int. Cl. G06F 17/60

(52) U.S. Cl. 705/8

(57) ABSTRACT

A method for scheduling work and delivery of material for items in a factory which includes obtaining a customer order, determining a current state of an available inventory of material from a plurality of material sources, generating a material request plan for producing the item using the customer order and the current state of the available inventory, and executing the material request plan. The customer order includes an item, having an associated quantity of a material to produce, ordered by a customer. The executing the material request plan includes netting deliveries of material with planned requests for material during the executing of the material request plan.

### BACKGROUND OF THE INVENTION

1. Field of the Invention

The present invention relates to manufacturing order scheduling and more particularly to recalculating planning requests within a manufacturing order scheduling and materials replenishment system.

2. Description of the Related Art

Scheduling work in a manufacturing environment is a complex process. Most factories use an automated planning and scheduling system to ensure that customer demand is satisfied in a timely manner with minimum inventory. To achieve this goal, such planning requires that work for each manufacturing line is efficiently scheduled, that the appropriate materials needed to complete each task performed are available when needed on the manufacturing line, and that products are manufactured in the order that the products are needed. To produce a manufacturing schedule, customer orders should be received and analyzed, priorities should be assigned to items to be manufactured, manufacturing resources should be allocated, work should be scheduled, raw materials and/or parts should be obtained and delivered to the manufacturing line, work in progress should be tracked, and variability in availability of raw materials and/or parts must be handled. Many manufacturing facilities plan and manage these many tasks by combining multiple computerized planning and scheduling systems with paper-based management systems.

An example of a widely-used commercially available automated planning and scheduling system is i2 Technologies, Inc.'s Factory Planner and Demand Fulfillment and Supply Chain Planner. The i2 Factory Planner generates work schedules and material requirements schedules using customer-provided inputs of demand and inventory. The i2 Demand Fulfillment application helps organizations to quote and promise order delivery to customers in real-time while obeying customer constraints on lot sizes, number of shipments, and time between shipments. The i2 Supply Chain Planner helps provide a global view of the entire supply chain from sourcing to delivery. These products handle the complicated scheduling for large, distributed, complex manufacturing environments. However, any automated planning and scheduling system can only produce accurate results if inputs to the system are accurate.

Most businesses schedule manufacturing activities based upon forecasts of demand for products. Work is typically scheduled on a daily or weekly basis to meet demand predicted based on past sales. Inputs to the automated planning and scheduling system are demand forecasts.

To ensure that demand is satisfied, most factories maintain inventories of both parts and/or raw materials. Each type of inventory typically includes stock to accommodate the average usage rate and stock to meet variations in demand. However, maintaining high inventory levels does not necessarily guarantee that the right inventory is available when and where it is needed. A material delivery schedule is needed that delivers material to the manufacturing line prior to the time the material is needed during manufacturing.

Furthermore, due to limited space in most factories and the expense of maintaining warehouses of inventory, it is desirable to maintain only the minimum inventory necessary to meet demand. Some factories operate on a build-to-customer-order model where no product is manufactured unless it has been ordered by a customer. This model enables the factory to operate with minimal inventory of finished products, but does not address the inventories of materials.

In addition to minimizing material inventory, it is also desirable to minimize material handling to ensure that materials are delivered to the right location at the right time.

Problems with scheduling manufacturing activities are exacerbated in a mass production manufacturing environment for commodities that are built to customer orders. The term commodity describes a mass-produced unspecialized product. In such an environment, the timeframes for manufacturing and delivery activities may be sub-hourly. Demand forecasts do not reliably predict material needs at this level, and schedules based upon demand forecasts become less and less accurate as time elapses between the time the work is scheduled and the time the work is initiated on the manufacturing line. Nor do demand forecasts respond to variations in material needs resulting from atypical customer orders. Scheduling based upon demand forecasts does not provide the responsiveness to changes in inventory and work schedules needed to ensure that materials are delivered to the right place at the right time.

It is known for a new plan generated from demand and supply data to consider previously requested materials (e.g., Purchase Orders or similarly generated requests) and consider previously unrequested availability to be available at fixed lead times (e.g., at X business days or Y hours in the future). A current planned request typically relied on an assumption of the static nature of all previous demand and supply inputs that were provided to the current plan generation.

More specifically, referring to FIG. 1, labeled prior art, when executing a planning cycle x−1, a planned request from a supplier does not take into account actual deliveries made by the supplier during the planning cycle (e.g., a supplier may only deliver material in pallets of 100 despite having a supply request of 90). Accordingly, at the end of the planning cycle x, the manufacturer may actually be in receipt of 10 more items than actually needed. This excess is acknowledged in planning cycle x+1 and actually taken into account when the x+1 plan is executed.

### SUMMARY OF THE INVENTION

Accordingly, a system which modifies planned requests occurring during a planning cycle based upon events that occur during the planning cycle is set forth. Such a system advantageously allows delivery overages to be addressed so that the overages do not accumulate across planning cycles.

In one embodiment, the invention relates to a method for scheduling work and delivery of material for items in a factory which includes obtaining a customer order, determining a current state of an available inventory of material from a plurality of material sources, generating a material request plan for producing the item using the customer order and the current state of the available inventory, and executing the material request plan. The customer order includes an item, having an associated quantity of a material to produce, ordered by a customer. The executing the material request plan includes netting deliveries of material with planned requests for material during the executing of the material request plan.

In another embodiment, the invention relates to a system for scheduling work and delivery of material for items in a factory which includes means for obtaining a customer order, means for determining a current state of an available inventory of material from a plurality of material sources, means for generating a material request plan for producing the item using the customer order and the current state of the available inventory, and means for executing the material request plan. The customer order includes an item, having an associated quantity of a material to produce, ordered by a customer. The executing the material request plan includes netting deliveries of material with planned requests for material during the executing of the material request plan.

In another embodiment, the invention relates to an apparatus for scheduling work and delivery of material for items in a factory which includes an obtaining module, a determining module, a generating module and a plan execution module. The obtaining module obtains a customer order. The customer order includes an item ordered by a customer. The item has an associated quantity of a material to produce. The determining module determines a current state of an available inventory of material from a plurality of material sources. The generating module generates a material request plan for producing the item using the customer order and the current state of the available inventory. The plan execution module executes the material request plan. The plan execution module includes a netting module. The netting module nets deliveries of material with planned requests for material during the executing of the material request plan.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows a timeline for planning requests.

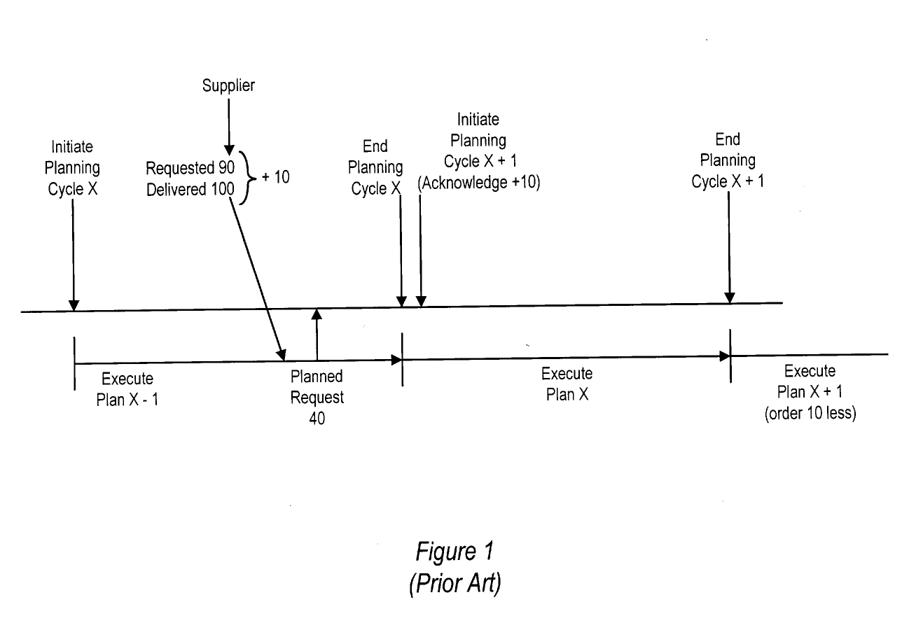

FIG. 2 is a flow diagram showing an example of a supply chain for a manufacturer having several factories.

FIG. 3 shows a timeline for scheduling work and delivery of materials for a manufacturing line, receiving deliveries of material from a hub, and initiating work on the manufacturing lines according to the work schedule.

FIG. 4 shows a timeline for recalculating planned requests based upon events that occur during a planning cycle.

FIG. 5 shows a high level order process which includes a demand fulfillment system of the present invention.

FIG. 6 shows the demand fulfillment system of the FIG. 5 high level order process.

### DETAILED DESCRIPTION

The following is intended to provide a detailed description of an example of the invention and should not be taken to be limiting of the invention itself. Rather, any number of variations may fall within the scope of the invention which is defined in the claims following the description.

In the demand fulfillment system and method of the present invention, the potential inefficiencies resulting from over delivery are overcome by modifying planned requests occurring during a planning cycle based upon events that occur during the planning cycle.

When a quantity of a material is scheduled to be used at an operation on a manufacturing line, the material is requested from the available inventory allowing sufficient time for delivery prior to the time the material is needed at the operation. When the material is accepted at the destination material source, the actual quantity of material that is received is compared against planned requests that occur during the execution of a plan and the planned requests are modified if necessary.

In the manufacturing environment described herein, a customer places a customer order for one or more products, such as an information handling system. A customer may be an individual or a business entity. The product(s) are built according to the specifications provided by the customer in the customer order and may include one or more components. Generally each component is a commodity that is mass-produced and unspecialized. For example, the customer ordering an information handling system may specify several components such as a processor, monitor, printer, and so on, each of which is mass-produced. The customer order specifies the particular components to be assembled to provide the information handling system product.

For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For simplification purposes, examples used herein may describe a customer order for a single item, an item may represent either a product or a component of a product as described above. The scope of the invention is not so limited, and the invention encompasses the fulfillment of customer orders for multiple products including multiple components. A customer order therefore may include many items and/or multiple quantities of a single item. When a customer order has a single item, as in some examples herein, the assignment of a manufacturing line to fulfill the customer order by manufacturing the item is also an assignment of a manufacturing line to the customer order.

Some items may be manufactured by the manufacturer and other items may be purchased from a supplier but sold as part of a product offered to customers. For instance, the manufacturer of the computer system described above may obtain a monitor from a supplier rather than manufacture the monitor itself.

The term material describes raw materials and/or parts used to manufacture an item. For items which are purchased from a supplier and not manufactured in-house, the term material may be used to describe the item itself.

The demand fulfillment system and method of the present invention generates a work schedule for items to be manufactured and a material delivery schedule for materials to be delivered to manufacture the items.

A work schedule includes a time and location for each item to be manufactured. The location may specify a manufacturing line and/or an operation of at least one operation on a manufacturing line to manufacture the item. A material delivery schedule identifies a material, a quantity, a material need-by time, and a delivery location (an operation and/or manufacturing line) for each material required to fulfill the work schedule. The material delivery schedule is used to ensure that materials needed to manufacture the items are delivered to the location they are needed on the manufacturing line prior to the time when manufacturing the item is to begin. The material delivery schedule is developed on a just-in-time basis so that materials are delivered to the manufacturing line just prior to the time that the material is needed for manufacturing the item.

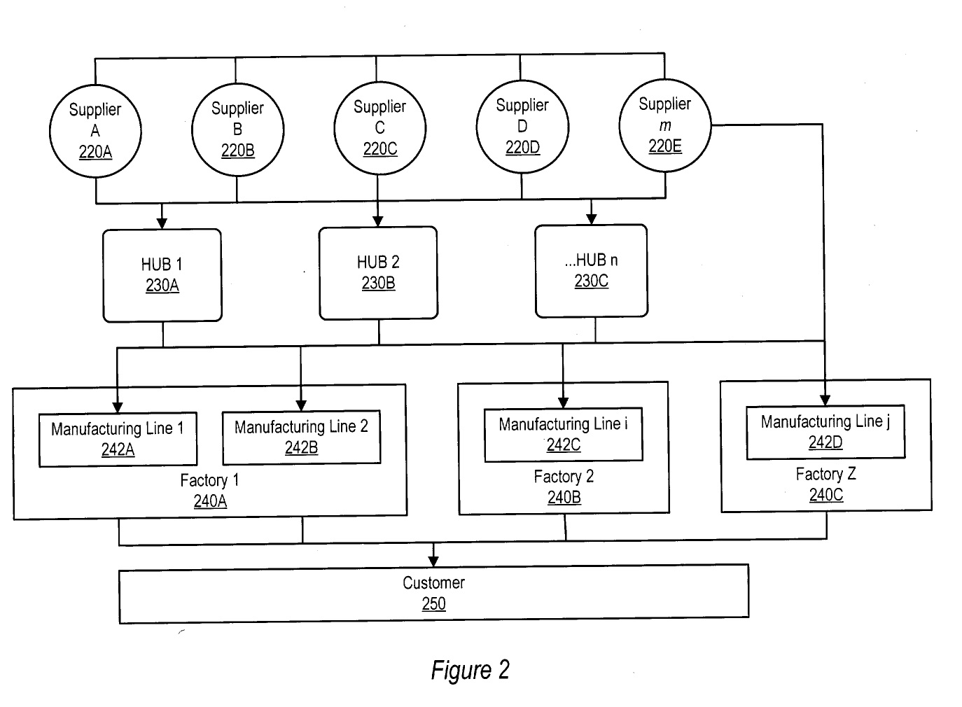

FIG. 2 shows a supply chain for a manufacturer of items according to one embodiment of the invention. Each supplier 220 such as suppliers 220A through 220E supplies parts and/or raw materials, collectively called materials, to the manufacturer. Rather than maintaining a warehouse of materials, the manufacturer obtains materials from at least one external material source. Examples of external material sources include hub 230A, hub 230B, and hub 230C and suppliers 220A through 220E. Each hub is in close proximity to one of the manufacturer's factories, each factory being a factory 240, such as factories 240A, 240B and 240C. Each factory has at least one manufacturing line such as manufacturing lines 242A through 242D. Each manufacturing line may have one or more manufacturing operations (not shown). For factories having multiple manufacturing lines, materials from hubs and suppliers are delivered directly to the operation and/or manufacturing line that needs the material rather than to a general delivery area that serves all operations and/or manufacturing lines for the entire factory.

The term hub describes an intermediate business that agrees with the manufacturer to maintain adequate levels of inventory of materials that can be delivered to the manufacturer's factory on short notice upon request. The hub makes its own arrangements with suppliers to provide material to a storage location for hub inventory. A hub may be referred to as a Supplier Logistics Center (SLC).

Suppliers may also supply parts and/or raw materials directly to the operation and/or manufacturing line upon request. In the context of the present invention, each external material source such as a hub or a supplier has its own inventory data (not shown). The manufacturer has access to the external material sources' inventory data. The manufacturer manufactures the finished products that have been ordered by customers such as customer 250.

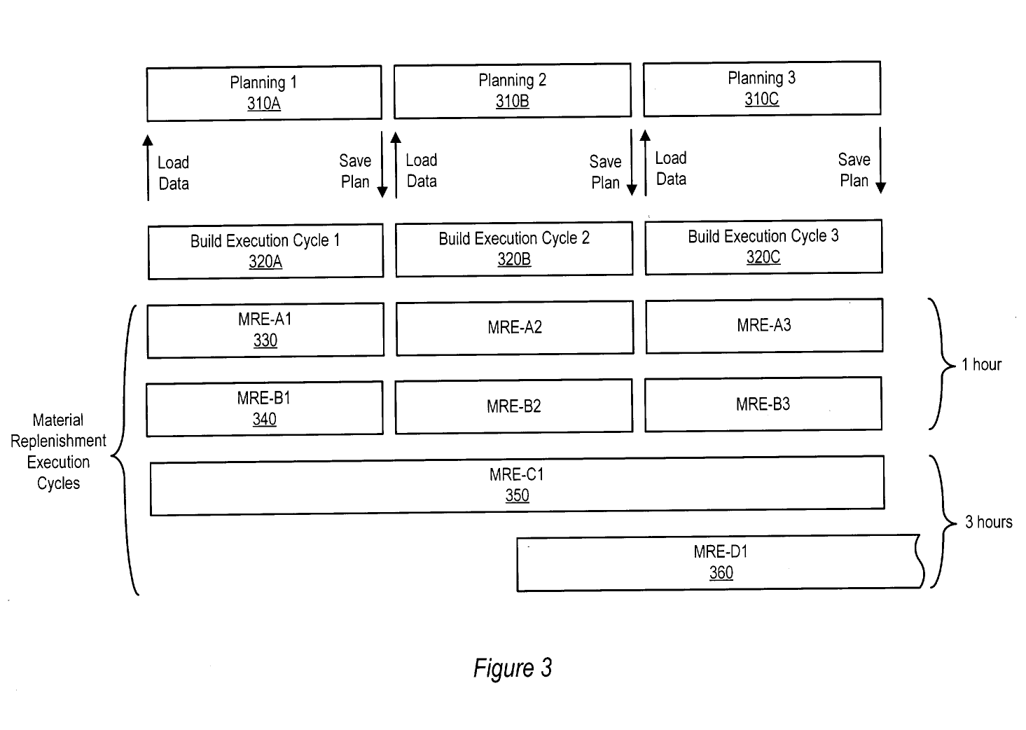

FIG. 3 shows an example of a timeline of activity on a manufacturing line according to the present invention. In this example, production scheduling activity (i.e., planning) is decoupled (i.e., executed separately) from material replenishment activity (i.e., plan execution). The material replenishment activity includes some or all of schedule transmission, materials requesting, build execution activity, and material movement. The production scheduling activity is executed substantially continuously as are materials requested from external material sources. The production scheduling activity accounts for planned initiation of material requests when generating a material request. Planned initiation of material requests are material requests that are anticipated to occur during the execution of the production scheduling module.

More specifically, at time 0:00, data is loaded into a planning module 310A so that a first production scheduling and planning cycle may be executed (Planning 1). The data that is loaded includes customer orders and available inventory. The planning module 310 develops a material request plan that schedules work and deliveries of materials to the factory's operations and/or manufacturing lines. Available inventory includes external inventory as shown in external inventory data, in this case, the hub's inventory data. Available inventory also includes in-house inventory of materials that were requested and delivered from an external material source, but that are not currently allocated to a customer order. While one of the goals of the present invention is minimize or eliminate the need for an in-house inventory of materials, excess materials may accumulate when work is rescheduled or when excess parts are delivered by an external material source. This in-house inventory may be stored in a storage room at a manufacturing line or in an excess stock storage room.

The timeline shows three examples of planning blocks that occur during an example time period: planning block 310A beginning at time 0:00, planning block 310B beginning at time 1:00, and planning block 310C beginning at time 2:00. For illustration purposes, planning block 310A is shown prior to any delivery of material to the manufacturing line. Planning blocks 310B and 310C illustrate scheduling after some material has been delivered by hubs to the manufacturing lines. This material from hubs was requested from the hubs during a preceding planning block. For example, for planning block 310C, available inventory includes in-house inventory of materials that were requested as a result of the plan developed during the execution of planning module 310B and delivered during hub delivery block 330B. Available inventory also includes materials available from external material sources, as shown in external inventory data.

However, because the production scheduling activity is decoupled from the material movement activity, a material request and movement block 320A may execute before the planning block 310A completes (e.g., at time 0:15). The material request and movement block 320A uses information derived from a prior planning block (not shown). In this way, material request and movement are not dependent upon the execution of a particular planning block.

In the example shown in FIG. 3, each planning block allows a set amount of time to generate a schedule (e.g., approximately 1 hour). The set amount of time for the planning block is based upon the length of time that the planning software needs to run. In each planning block, such as planning block 310A beginning at time 0:00, a schedule is generated for all operations on all manufacturing lines using all outstanding customer orders and all available inventory. A schedule includes a work schedule for work to manufacture items in response to outstanding customer orders and constrained by material availability (i.e., a build execution schedule). A schedule also identifies material requirements and may provide a material requirements schedule for materials to be used to perform the work. The work schedule identifies the items to be manufactured and a start time and location (operation and/or manufacturing line) for manufacturing each item.

The customer order identifies the materials that are needed to manufacture the item. An availability scheme may be used to assign inventory to a particular customer order to be built. It is desirable to use the most readily available material and thus material is provided with an associated availability rating. For example, in one embodiment, unused in-house inventory already at the storage room for the manufacturing line assigned to the customer order receives the highest availability rating to be used in the next work schedule. In-house inventory stored in an excess stock storage room in the factory is given second highest availability rating; hub inventory is given the third highest availability rating; and in-house inventory in a storage room for another manufacturing line is given the lowest availability rating. This availability scheme minimizes in-house moves of materials. Other embodiments may use other methods or other priority schemes to assign materials to customer orders.

A material delivery schedule (i.e., a material replenishment execution schedule) is developed from the work schedule and the manufacturing requirements so that all materials to be used in manufacturing an item are available at the operation and/or manufacturing line at the time needed for manufacturing the item. The material replenishment execution schedule may include staggered delivery of materials to the manufacturing line as items are being manufactured, as long as the material is available at the operation and/or manufacturing line when it is needed (See, e.g., MRE-A, MRE-B, MRE-C and MRE-D).

The present invention allows multiple planning blocks to occur during a single manufacturing shift. The term manufacturing shift describes a typical manufacturing shift of approximately 8 hours during which mass production of items is continuously performed, although the number of hours in a manufacturing shift may vary. The multiple planning blocks produce work schedules and material delivery schedules for a single manufacturing line during each manufacturing shift. Each subsequent planning block overlays a revised work schedule and material delivery schedule over the previously planned work schedule and material delivery schedule. The planning blocks produce a rolling work schedule and material schedule that extends beyond the manufacturing shift. Planning work and material deliveries multiple times during the shift enables the factory to respond to changing material needs of each manufacturing line on a very short-term basis. Consider the example of FIG. 3 with planning blocks executing substantially continuously (i.e., executing as soon as the data required to execute the new planning block is loaded from the previous planning block). The schedule produced is used to initiate a work schedule after the planning block ends and to generate a material delivery schedule for deliveries until a revised material delivery schedule is generated by a subsequent planning block. Accordingly, when a new planning block occurs, the schedule generated overlays all existing material requests which have not already been sent.

Replenishment time (i.e., lead time) for material is dynamically calculated when planning work schedules. For example, if material that is needed is part of hub inventory, the work schedule allows for the replenishment time to move the material from the hub inventory to the manufacturing line. Work using that material is not scheduled until after the replenishment time has passed. Replenishment time may also be needed for in-house inventory, but it should be shorter than the replenishment time needed for an external material source. Replenishment lead time for materials that are currently at the hub is calculated based on the expected time for the planning block to complete, the time needed by the manufacturer to evaluate and adjust material requirements, the time needed by the hub to consolidate materials, load the truck and transport the material to the factory, the static delivery schedule for that hub to that factory and the time needed to move materials to the location where the materials will be consumed.

By taking account of replenishment time in planning work, the planning system ensures that work is not scheduled to begin until all parts and/or materials needed for manufacturing the item are delivered to the operation and/or manufacturing line. Orders are not scheduled that cannot be completed due to missing parts.

At time 1:00, the plan is provided to the manufacturing line and work included in the work schedule. Each new materials request is based upon the latest saved plan data and thus the material requests and execution block 320B use the saved plan from planning block 310A.

The materials delivered prior to the next planning block are available as inventory for work to be subsequently scheduled. For example, materials that arrive prior to the execution of the planning block 310B are available as part of in-house inventory for planning block 310B. According to the present invention, material is requested so that the material received in response is available at the manufacturing line just in time for manufacturing the item. Material requests are made to ensure that a delivery of material in response to the material request is destined for a single manufacturing line.

Each planning block such as planning blocks 310A, 310B, and 310C produces another work schedule using all available customer orders and all available inventory. Additionally, build execution cycle blocks 320A, 320B, and 320C and material replenishment execute cycle (MRE) blocks 330, 340, 350 and 360 use the most recent saved plan to generate materials requests.

In the embodiment of the invention illustrated in FIG. 3, the work schedule is generated independently of previously generated work schedules, although other embodiments may update a previously generated work schedule. Additionally, subsequent planning blocks, when loading new data, add materials that the planning block plans to order during the planning run as planned in-transit materials. Additionally, supplier commitments to earlier requests are compared with the original requested quantity. Net differences are used to adjust new requests. Often the work schedule generated at a given time corresponds directly to the work schedule generated in a later planning block, for the work scheduled for the same time period. However, changes in customer orders and available inventory during the time between planning may result in differences between work schedules and thus the new schedule overlays the previous schedule.

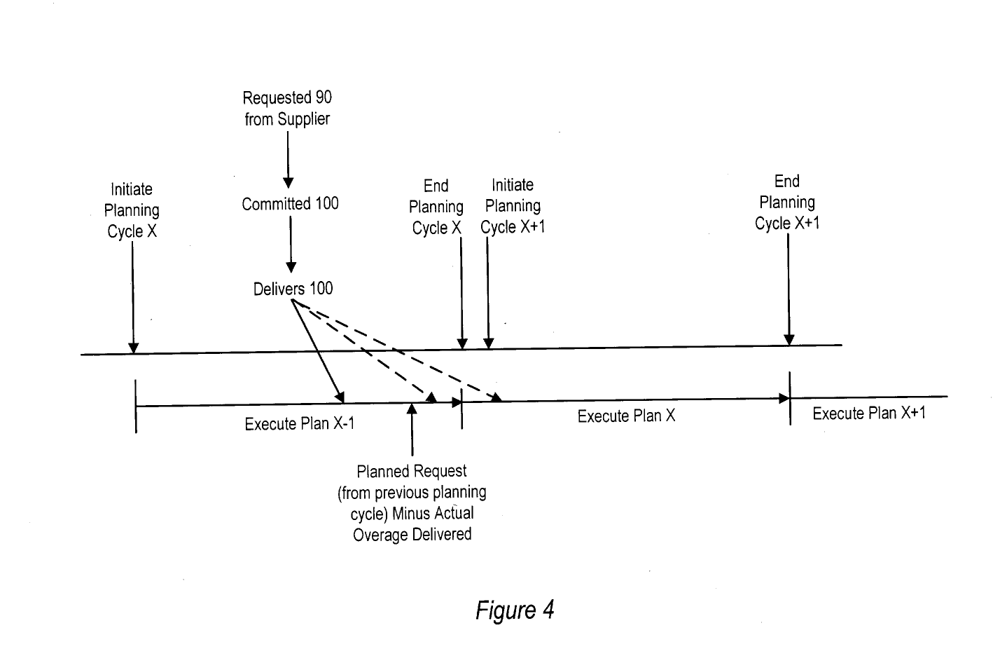

FIG. 4 shows a timeline for recalculating planned requests based upon events that occur during a planning cycle. More specifically, when executing a planning cycle x−1 and a planned request from a supplier (which request may have been from planning cycle x−2) results in actual deliveries of more material than is planned requested, then during the executing of planning cycle x−1, a planned request for the same material acknowledges that this excess material is being delivered, takes this excess material into account when executing a planned request during the x−1 execution cycle and revises the planned request so as to reflect the excess material. I.e., the planned request during the x−1 planning cycle is recalculated to be the planned request minus overage delivered and the original plan is revised to reflect the new planned request. Delivered material includes both committed deliveries as well as actual deliveries. The delivery may occur prior to or after a planned request as long as the delivery is committed, the delivery is netted out. Additionally, at the end of the execution of planning cycle x−1, the planned requests are again reviewed to determine whether there is any remaining overage. If so, then this overage is taken into account (i.e., netted out) when performing future requests and as input data for the next planning cycle.

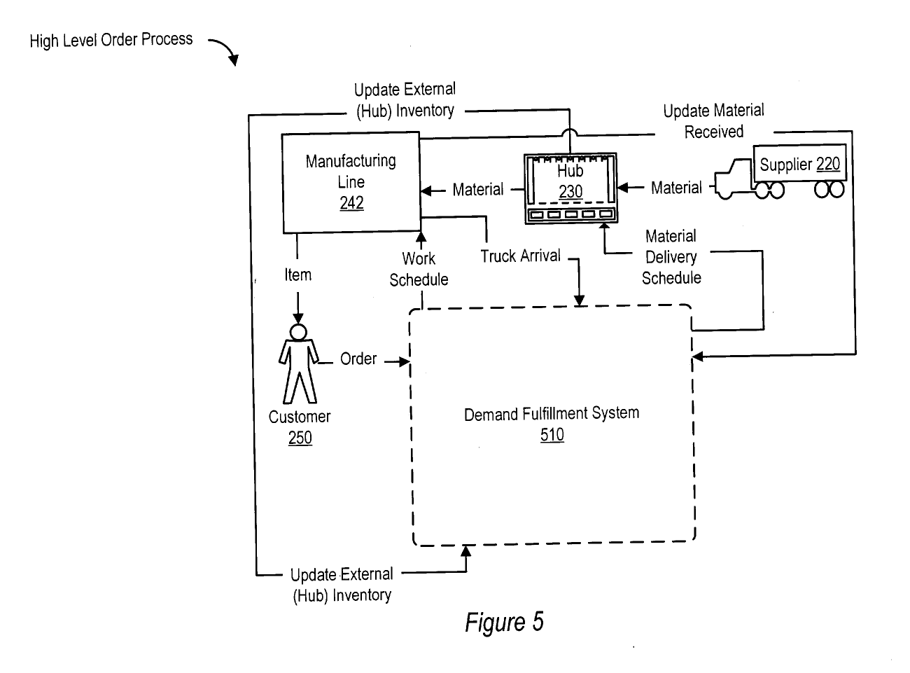

FIG. 5 shows the interaction of the demand fulfillment system 510 with a high level order process. More specifically, the demand fulfillment system 510 is coupled to and interacts with the manufacturing line 242. The demand fulfillment system 510 also interacts with and is coupled to a hub 230, which is an example of an external material source. The hub 230 receives material from suppliers 220 and provides material to the manufacturing line 242. The hub 230 receives information regarding material delivery schedule from the demand fulfillment system 510. The demand fulfillment system 510 also provides information regarding a work schedule to the manufacturing line 242 and receives information regarding material arrival from the manufacturing line 242. The demand fulfillment system 510 also recalculates planned requests during the execution of the planning cycle based upon actual material delivered.

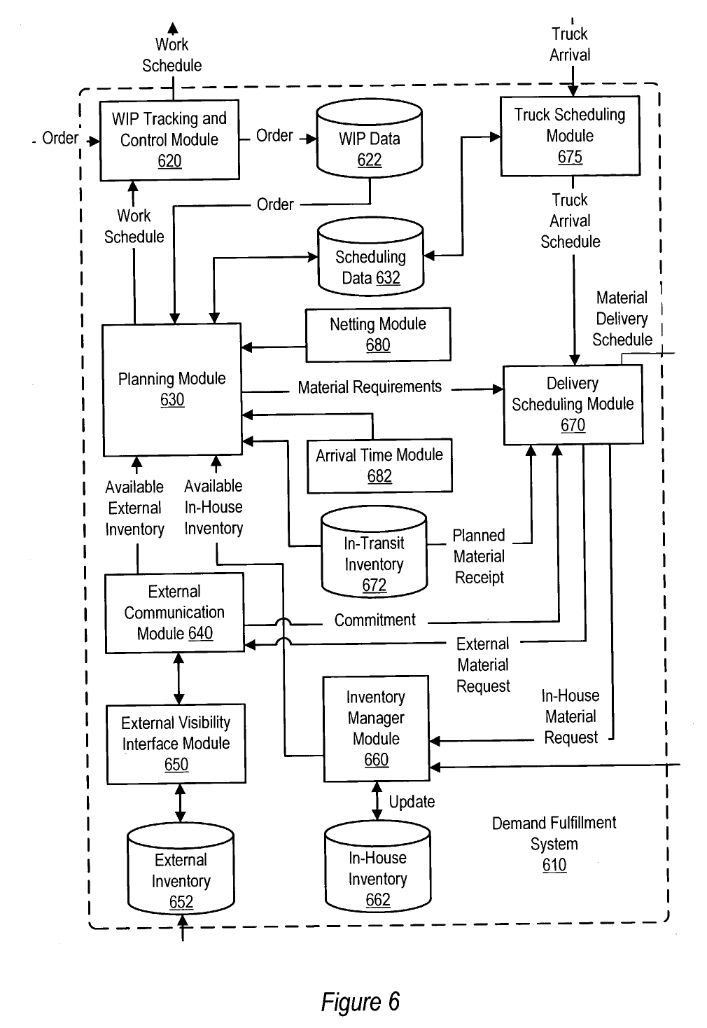

FIG. 6 shows the interactions between modules of demand fulfillment system 510. In one embodiment, the functions of planning module 630 are provided by i2 Factory Planner and the functions of Hub Communication module 640 are provided by i2 Rhythm Collaboration Planner. The invention is not limited to this embodiment, and the functions performed by each of these modules may be performed by modules specially developed for the demand fulfillment system, by a single module, or by other commercially available software.

In some embodiments, the functions of some modules of demand fulfillment system 510 may be provided by commercially available software packages. Other modules may manipulate the inputs and/or outputs as well as provide the necessary interfaces to in-house systems or external systems. For example, inputs are manipulated so that the output of the commercially available software packages is accurately based upon demand derived from customer orders, using materials available from in-house and hub inventory, and with replenishment times taken into account in scheduling work and deliveries of materials. Further manipulation of the output of the commercially available software may be necessary.

WIP Tracking and Control module 620 controls work in progress (WIP) in the various manufacturing lines of the manufacturer, such as manufacturing line 242. When a customer 150 places a customer order, WIP Tracking and Control module 620 stores the customer order in WIP data 622 which is available to Scheduling module 675.

Planning module 630 develops a work schedule using the customer order and various other inputs, as will be described below. Ultimately, Planning module 630 provides the work schedule that is used by WIP Tracking and Control module 620 to control the operations performed on the manufacturing lines, such as manufacturing line 242. Planning module 630 also provides the material requirements that will be needed to perform the work schedule. Delivery Scheduling module 670 uses the material requirements to develop a material delivery schedule for delivery of materials to the operations and/or manufacturing lines.

Planning module 630 also compares the parts and/or raw materials needed to fulfill the customer order with available inventory to determine whether additional materials are needed to manufacture an item of the customer order. Because minimal inventory is maintained at the manufacturing lines, material requests must be issued to move materials to the manufacturing line, both from in-house inventory and from external inventory. Available external inventory and available in-house inventory comprise the available inventory that may be used to fulfill the material request. Planning module 630 may use and/or generate schedule data 632 to determine materials to perform certain work; for example, the material replenishment time may be used as part of identifying available inventory to fulfill the customer order.

Delivery Scheduling module 670 determines when a material request should be generated, typically at the last possible moment that will still meet a request deadline. The materials received in response to in-house material requests and external material requests are expected to be in place when the material is needed for manufacturing the item. Delivery Scheduling module 670 generates an in-house material request to Inventory Manager module 660, which manages in-house inventory, and/or an external material request such as a hub material request to External Communication module 640.

When Delivery Scheduling module 670 communicates an in-house material request, Inventory Manager module 660 obtains the available in-house inventory from In-House Inventory data 662. Inventory Manager module 660 communicates the available in-house inventory to Planning module 630. Available in-house inventory typically excludes in-house inventory already allocated to another customer order.

External Communication module 640 facilitates communication between the manufacturer and external delivery sources. When Delivery Scheduling module 670 communicates a hub material request, External Communication module 640 determines whether external inventory (here, hub inventory) is sufficient to meet the material request via External Visibility Interface module 650. External Visibility Interface module 650 provides an interface to external inventory data 652, which is data maintained by the external material source (the hub or supplier) rather than by the manufacturer. External Communication module 640 obtains a commitment from the external material source (here, the hub) for the amount of material the hub commits to provide to meet the material request.

External Communication module 640 communicates the available external inventory to Planning module 630. If an external material source cannot fulfill the entire material request, the manufacturer is automatically informed of the shortage via the commitment. The manufacturer can coordinate with the external material source to re-stock external inventory to meet demand and/or use another source. Netting module 680 communicates net out information to Planning module 630. The netting module 680 nets out from a next material request material that is committed from the hub in excess to the original request. The netting out is based on matching destination and part numbers of the material. The netting module 680 also nets excess receipts from planned requests without waiting for the next planning cycle by identifying actual delivered material versus planned material requests. If an overage is detected, this overage information is provided to the planning module 630. Thus, the netting module 680 prevents over ordering of material.

Arrival Time module 682 communicates material arrival times to Planning module 630. The arrival time module 682 allows an arrival time to be factored into planning. The true arrival time is based upon the time that a truck is scheduled to arrive plus the time to get the material to the manufacturing line (i.e., the replenishment time). Accordingly, a late night execution of the planning module knows that material won't be available until a certain time the next day and will start scheduling orders based upon the true availability of the material.

In one embodiment of the invention, the demand fulfillment system and method also tracks in-transit inventory, also shown in FIG. 6 as in-transit inventory 672. In-transit inventory is inventory that has been committed by an external material source but not yet received at the manufacturing line. When a commitment from an external material source is received, Delivery Scheduling Module 670 uses the commitment to update in-transit inventory with a planned material receipt, thereby adding the material to in-transit inventory. In this embodiment, in-transit inventory is considered to be part of the available inventory and is used by Planning module 630 for scheduling work. When in-transit inventory is received at the manufacturing line, the material request is“closed” by“zeroing out” the corresponding in-transit inventory and adding the received material to in-house inventory.

Delivery Scheduling module 670 uses the material requirements generated by Planning module 630 and a truck arrival schedule to produce a material delivery schedule. The term truck arrival schedule is used herein to describe scheduled deliveries of available inventory to operations and/or manufacturing lines. A delivery to an operation corresponds to a delivery to an operation material source for the operation. A truck arrival schedule includes in-house deliveries from in-house inventory and/or deliveries of materials from external material sources. The term truck as used herein describes the transport mechanism used to move material from its storage location to the operation and/or manufacturing line.

A truck arrival schedule is used as input for each generation of a material delivery schedule to allow the factory to quickly adapt to changes in material needs and thus to schedule additional or fewer material deliveries.

When materials are received and/or distributed from in-house inventory, this information is entered into Inventory Manager module 660 and in-house inventory data 662 is updated. The arrival of a truck of materials is also entered into Truck Scheduling module 675, which maintains the truck arrival schedule of trucks scheduled to deliver materials from external inventory and/or in-house inventory.

By using a priority scheme to assign materials to customer orders such as that described above, the demand fulfillment system and method of the present invention are designed to ensure that in-house moves of material are rare and that in-house distribution of materials is performed as efficiently as possible. In addition, material requests are made so that each delivery of material is destined for a single operation and/or manufacturing line.

The term automated data warehouse is used to refer collectively to WIP data 622, which provides a outstanding customer orders and a current available work-in-progress inventory of materials in work in progress and not in storage; in-house inventory data 662, which provides a current available in-house inventory of materials for materials that are in stockrooms and at operations but not in work-in-progress, external inventory 652, which provides a current available external inventory at suppliers and hubs; in-transit inventory 672, which provides a current available in-transit inventory; and scheduling data 632, which provides other types of data needed to produce the work schedule and the material delivery schedule. The term current state of the available inventory includes current available work-in-progress inventory; current available in-transit inventory; current available in-house inventory, and current available external inventory. The available inventory included in the automated data warehouse is updated continuously from its respective sources. For example, WIP data 632 is updated by WIP tracking and control module continuously. In the preferred embodiment, data from each of these respective sources is updated no less than every ten minutes.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the described embodiment generates a schedule that reflects all outstanding customer orders and all inventory which is then analyzed to produce a work schedule and a material delivery schedule. Other embodiments may use only a subset of outstanding customer orders and available inventory to generate one or more schedules. Such variations are contemplated within the scope of the invention.

Also for example, the described embodiment recalculates planned requests for a single line, recalculating planned requests across multiple lines is also contemplated. Also, when recalculating planned requests across multiple lines, the demand fulfillment system 510 might take into account overages delivered to one line when calculating requests for another line. The demand fulfillment system 510 may take this information into account only for lines that are physically related in some way (e.g., are located within the same factory) or for lines that are producing the same types of items. Accordingly, the demand fulfillment system 510 may identify relationships between multiple lines and use these relationships when netting out planned requests.

The above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for scheduling work and delivery of material for items in a factory comprising:
obtaining a customer order, the customer order including an item ordered by a customer, the item having an associated quantity of a material to produce;
determining a current state of an available inventory of material from a plurality of material sources;
generating a material request plan for producing the item using the customer order and the current state of the available inventory;
executing the material request plan, the executing the material request plan including netting deliveries of material with planned requests for material during the executing of the material request plan.

2. The method of claim 1 wherein
the customer order and the current state of the available inventory are used to generate a subsequent work schedule and the material delivery schedule.

3. The method of claim 1 wherein
the obtaining the customer order includes using a status for the customer order, the status for each customer order being updated continuously; and
the status for each outstanding customer order corresponds to an outstanding status.

4. The method of claim 1 wherein
the available inventory comprises external inventory.

5. The method of claim 1 wherein
the available inventory comprises work-in-progress inventory.

6. The method of claim 1 wherein
the available inventory comprises in-transit inventory.

7. The method of claim 1 wherein
the available inventory comprises in-house inventory.

8. The method of claim 1 wherein
the material source includes an external material source, the external material source providing an external inventory of the material of the available inventory; and
the determining the available inventory of the material includes using an external visibility interface module to determine the available inventory of the first material in the external inventory.

9. The method of claim 1 wherein
the material request plan takes into account a true arrival time of the material.

10. The method of claim 1 wherein
the material request plan takes into account material requests that were netted out of an earlier execution cycle.

11. The method of claim 1 wherein
the item is an information handling system.

12. The method of claim 1 wherein
the deliveries include committed deliveries.

13. The method of claim 1 wherein
the deliveries include actual deliveries.

14. A system for scheduling work and delivery of material for items in a factory comprising:
means for obtaining a customer order, the customer order including an item ordered by a customer, the item having an associated quantity of a material to produce;
means for determining a current state of an available inventory of material from a plurality of material sources;
means for generating a material request plan for producing the item using the customer order and the current state of the available inventory;
means for executing the material request plan, the means for executing the material request plan including means for netting deliveries of material with planned requests for material during the executing of the material request plan.

15. The system of claim 14 wherein
the customer order and the current state of the available inventory are used to generate a subsequent work schedule and the material delivery schedule.

16. The system of claim 14 wherein
the obtaining the customer order includes using a status for the customer order, the status for each customer order being updated continuously; and
the status for each outstanding customer order corresponds to an outstanding status.

17. The system of claim 14 wherein
the available inventory comprises external inventory.

18. The system of claim 14 wherein
the available inventory comprises work-in-progress inventory.

19. The system of claim 14 wherein
the available inventory comprises in-transit inventory.

20. The system of claim 14 wherein
the available inventory comprises in-house inventory.

21. The system of claim 14 wherein
the material source includes an external material source, the external material source providing an external inventory of the material of the available inventory; and
the means for determining the available inventory of the material includes means for using an external visibility interface module to determine the available inventory of the first material in the external inventory.

22. The system of claim 14 wherein
the material request plan takes into account a true arrival time of the material.

23. The system of claim 14 wherein
the material request plan takes into account material requests that were netted out of an earlier execution cycle.

24. The system of claim 14 wherein
the item is an information handling system.

25. The system of claim 14 wherein
the deliveries include committed deliveries.

26. The system of claim 14 wherein
the deliveries include actual deliveries.

27. An apparatus for scheduling work and delivery of material for items in a factory comprising:
an obtaining module, the obtaining module obtaining a customer order, the customer order including an item ordered by a customer, the item having an associated quantity of a material to produce;
a determining module, the determining module determining a current state of an available inventory of material from a plurality of material sources;
a generating module, the generating module generating a material request plan for producing the item using the customer order and the current state of the available inventory;
a plan execution module, the plan execution module executing the material request plan, the plan execution module including a netting module, the netting module netting deliveries of material with planned requests for material during the executing of the material request plan.

28. The apparatus of claim 27 wherein
the customer order and the current state of the available inventory are used to generate a subsequent work schedule and the material delivery schedule.

29. The apparatus of claim 27 wherein
the obtaining the customer order includes using a status for the customer order, the status for each customer order being updated continuously; and
the status for each outstanding customer order corresponds to an outstanding status.

30. The apparatus of claim 27 wherein
the available inventory comprises external inventory.

31. The apparatus of claim 27 wherein
the available inventory comprises work-in-progress inventory.

32. The apparatus of claim 27 wherein
the available inventory comprises in-transit inventory.

33. The apparatus of claim 27 wherein
the available inventory comprises in-house inventory.

34. The apparatus of claim 27 wherein
the material source includes an external material source, the external material source providing an external inventory of the material of the available inventory; and
the determining the available inventory of the material includes using an external visibility interface module to determine the available inventory of the first material in the external inventory.

35. The apparatus of claim 27 wherein
the material request plan takes into account a true arrival time of the material.

36. The apparatus of claim 27 wherein
the material request plan takes into account material requests that were netted out of an earlier execution cycle.

37. The apparatus of claim 27 wherein
the item is an information handling system.

38. The apparatus of claim 27 wherein
the deliveries include committed deliveries.

39. The apparatus of claim 27 wherein
the deliveries include actual deliveries.
